(19) United States
(12) Patent Application Publication
(10) Pub. No.: US 2021/0317996 A1
(43) Pub. Date: Oct. 14, 2021

(54) SOLAR SPACE HEATING COLLECTOR

(71) Applicant: Dale P. Schneider, Brentwood, TN (US)

(72) Inventor: Dale P. Schneider, Brentwood, TN (US)

(21) Appl. No.: 17/264,235

(22) PCT Filed: Jul. 31, 2019
(86) PCT No.: PCT/US19/44486

§ 371 Date: Jan. 28, 2021

Related U.S. Application Data
(60) Provisional application No. 62/712,664, filed on Jul. 31, 2018.

(51) Int. Cl. F24D 5/00; F24D 5/04; F24S 10/40; F24S 10/50; F24S 20/67

(52) U.S. Cl. CPC F24D 5/005; F24D 5/04; F24S 20/67; F24S 10/502; F24S 10/40

(57) ABSTRACT

An improved solar space heater collector may be constructed having a frame with extruded HDPE sides. The sides may have insulating pockets, as well as internally directed extensions for supporting at least one of insulation, absorbers, and/or baffles. Externally and downwardly directed fins may cooperate with shingles and/or flashing to facilitate a proper watertight connection of the collector to the roof. Finally, an improved jaw retainer may have a dual durometer grip which cooperates with a top glass.

### CROSS-REFERENCE TO RELATED APPLICATIONS

This non-provisional patent application claims the benefit of U.S. Provisional Patent Application No. 62/712,664 filed on Jul. 31, 2018. The disclosure of the above application is incorporated herein by reference.

### FIELD OF THE INVENTION

The present invention relates to the field of solar space heating system in which return air normally from a home or other building is directed through a solar collector where it is heated. Treated air is normally returned to the building. More particularly, many embodiments of the present invention relates to solar space heating collectors having improved efficiencies and/or constructions over prior art designs used for solar space heating applications although other applications such as solar water heating could use the technology discussed herein.

### BACKGROUND OF THE INVENTION

Solar voltaic panels are widely known and are utilized to create electricity from solar energy. However it is believed that crystalline silica based devices have a theoretical limiting efficiency of roughly 29%.

Additionally, various solar collector designs are utilized for heating water. While heating water can. certainly be accomplished with solar energy, it is believed that eliminating the average water heating cost for a home might translate to a $30 or $40 a month savings. One could perform a cost/benefit analysis to ascertain when the payback of the solar hot water heater might justify the expense. However, solar hot water heaters can be an excellent way to save on energy expenses.

While using solar energy to heat water is certainly one cost saving approach, there are also a limited number of solar space heating systems which have been constructed and installed over the years. In one of the applicant's former companies, Panel-15 from Weyerhaeuser was utilized to fabricate collector boxes and bonnets which connected the collectors to roofs, for at least some installations. A copper sheet was placed in the collector box beneath a top glass. Air was then circulated in between the copper and the glass from an inlet to an outlet, and thus heated air flow was then directed back into the home. This system proved to provide significant energy savings for heating during the daylight hours. Panel 15 is a plywood product having an aluminum layer laminated thereto sold by Weyerhaeuser.

Conservatively, energy savings for the homeowner sustained during daylight hours using the prior art solar heating system were roughly one third. In most installations, space solar heaters could provide much of the necessary heating for a home during daylight hours. While the prior art the Panel 15 collectors are currently in use in Michigan and other states, an improved design is believed to be necessary and desirable.

### SUMMARY OF THE INVENTION

It is an object of many embodiments of the present invention to provide an improved solar space heater collector.

It is another object of many embodiments of the present invention to provide an improved solar collector box having improved construction.

It is another object of many embodiments of the present invention to provide an improved solar collector box having an improved glass retention system.

It is another object of many embodiments of the present invention to provide a solar collector box having an improved roof mating system.

It is another object of many embodiments of the present invention to provide an improved solar space heating system.

Accordingly, a presently preferred embodiment of the present invention provides an improved solar space heating collector such as made out of HDPE, high density polyethylene, or other suitable material. The sides of the collector may preferably be extruded for at least some embodiments. Other manufacturing methods may be employed for other embodiments. An integral downwardly and outwardly extending fin may be provided with at least some embodiments which may cooperate with flashing or roofing material for installation. Insulated portions such as integral air spaces can be provided for at least some embodiments to provide an insulating effect within or at least on the sides which is believed to be a significant improvement over aluminum constructions.

Instead of utilizing a large O-ring seal about or at least proximate to a perimeter of a glass top as was relied upon for prior art designs, for many embodiments dual durometer extrusions may be provided with a retainer to receive a glass top plate. Other embodiments may utilize O-ring(s) or other seals.

Prior art collector plates typically have an absorber with a dimpled surface such as approximately 0.06 indents. The collector plate of one preferred embodiment provides indentions of about 0.25 if not greater. What used to begin with an eight foot long pieces of foil roll formed to then cover an eight foot long section for prior art constructions, now may utilize a sixteen foot piece of copper which after treatment is reduced to eight feet of length with significantly more surface area than prior art designs.

Furthermore, prior art designs employed an aluminum retention mechanism which covered one inch of glass on all four sides. Many embodiments of the applicant's new design reduce the covering of the glass edges to approximately 0.5 inches thereby adding roughly two more square feet of collector surface and thus increasing the potential output for each panel.

### BRIEF DESCRIPTION OF THE DRAWINGS

The particular features and advantages of the invention as well as other objects will become apparent from the following description taken in connection with the accompanying drawings in which:

FIG. 1 shows a top perspective view of the presently preferred embodiment of a solar space collector of a presently preferred embodiment of the present invention;

FIG. 2 shows a cross sectional view taken along line A-A of FIG. 1;

FIG. 3 shows a schematic view of the solar collector of FIGS. 1 and. 2 installed in a first configuration; and

FIG. 4 shows a schematic view of the solar collector of FIGS. 1 and 2 installed in a second configuration.

### DETAILED DESCRIPTION OF THE PREFERRED EMBODIMENT

FIG. 1 shows a presently preferred embodiment of a solar collector 10 with its top glass 12 shown removed in an exploded view as it would normally be connected to the frame 14 when in use. This embodiment is presently preferred for space heating applications, but other embodiments may be useful with solar water heating and/or other applications.

The glass 12 may preferably be a. tempered glass such as a low iron tempered glass glazing panel. One preferred embodiment utilizes Soltemp 156 which is believed to be imported from Israel. However, other embodiments may use other glass panels, while with other embodiments translucent and/or transparent glass panels or other materials may be used as may be available or desired. Furthermore, modeled glass may be utilized for some embodiments.

A system of baffles 16 may preferably be located internal to the frame 14 between glass 12 and absorber 18. The baffles 16 may be utilized to increase the length of travel of air flow from an entrance such as inlet 20 to outlet 22 in an effort to increase the amount of heat transfer to the air as it is moved from inlet 20 to the outlet 22 to elevate the temperature of the exiting air. Heated air is normally allowed to rise through the baffles 16. Baffles 16 may increase the length of travel from 1.5×, 2×, 3×, 4×, 5× or other factor. Of course, not all embodiments necessarily require baffles 16. The applicants understand that using baffles 16 often increases heat transferred to the air.

Absorbers 18 could alternately be copper wool or other material(s) in various forms. Copper wool is somewhat similar or dissimilar construction to steel wool which is often utilized preferably in refinishing or other uses. Copper may have attractive material qualities, but for some embodiments other materials in various forms could be utilized in various for absorbers 18. Furthermore, in the presently preferred embodiment, instead of using copper wool, which can be used for some embodiments, a copper foil sheet is utilized. A wool style is not believed to be in use and allows for air through the wool.

In prior art constructions, an eight foot Jong strip of sheer foil was roll formed to provide 0.06 indents to provide an eight foot long absorber. This increased the surface area of the copper foil without significantly increasing its length. In some embodiments, the applicant discovered that greatly increasing the surface area of the absorber may be desirable. In the present preferred embodiment, indents are raised to 0.25 inches and may be provided in some embodiments somewhat similar to a series of folds like “vees.” When manufacturing this style indent, the applicant has been using sixteen foot strips, which after processing, form eight foot lengths for use in the collector 10.

Between the absorber 18 and the top glass 12, and past the baffle 16, if utilized, air flow is directed into an air chamber 24 where the air is heated. Temperature in the air chamber 24 can exceed 400 degrees Fahrenheit on a clear, sunny day for at least some embodiments. Even on a cloudy day, temperatures internal to the heat chamber 24 could exceed 200 degrees Fahrenheit for at least some embodiments.

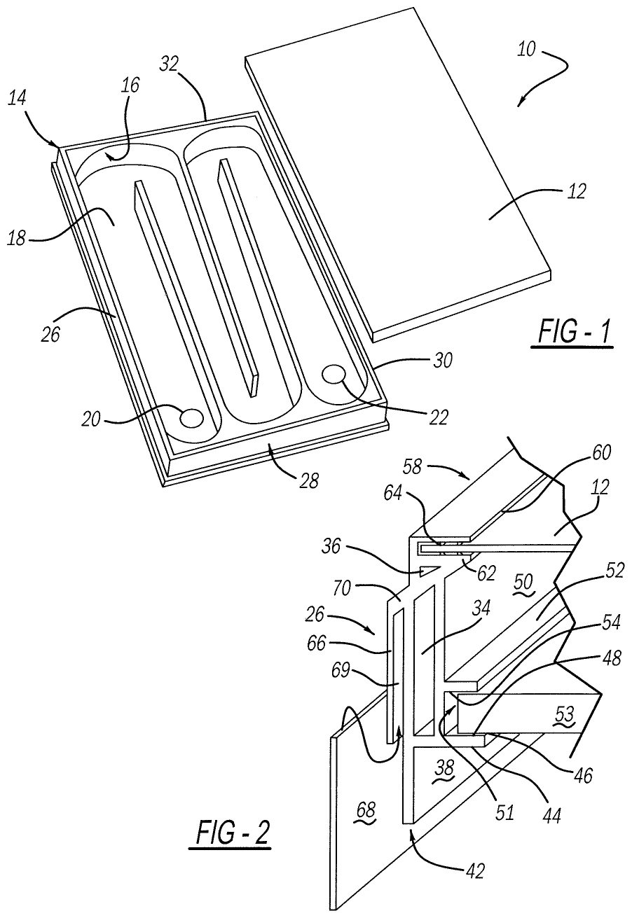

A cross section of a presently preferred side or frame member 26 can be seen with reference to FIG. 2. Other frame members 28, 30, 32 may be similarly or dissimilarly constructed. Frame member 26 may be an extruded HDPE (high density polyethylene) or other material. Frame member 26 may also be manufactured by other methods other than extrusion. However, extrusion has been found to be a particularly cost effective while providing high quality frame members 26. Frame member 26 preferably has at least one, if not a plurality, of insulating portions such as pockets 34, 36 illustrated, which may preferably provide additional insulating capability to facilitate reduction of heat loss through the frame members 26-32 so that the heat collected in the heat chamber 24 is directed to the outlets 22 and thus utilized for heating instead of being lost external to the frame 14 as will be described in further detail below and has occurred with prior art designs. Other insulation techniques may be employed with various embodiments.

The frame member 26 preferably has a support 38 with a lower portion 40. Support 38 can be utilized to space a bottom 42 from a lower surface 44 of extension 46 if utilized. Pockets 34 may be at least partially located between support 38 and inner wall 50. Extension 46 may also have an upper surface 48 which can extend from support 38 and also provide a base for inner wall 50 if utilized. Air pocket 34 can provide additional insulation for at least some embodiments.

A ledge 52 may or may not be provided. When a ledge 52 is provided, a lower surface of the ledge 52 may cooperate with the upper surface 48 and the extension 46 to provide a slot 51 which may allow the insertion of insulation 53 such as one inch Thermax or other appropriate insulating material on top of insulation. Of course, the insulation 53 could also be provided below the extension 46, if utilized, including in other embodiments. Above the insulation is preferably located the absorber 18 such as can rest on the insulation 53, an upper surface 56 of the ledge 52 or elsewhere such as on the insulation 53, etc. Baffle 16 may then be located there atop and/or above, if utilized, to cooperate therewith as explained above and would be understood by those of ordinary skill in the art. Baffle 16 preferably extends to span substantially the elevation between the top glass 12 and at least atop of the absorber 18 for many embodiments, and may be constructed of an appropriate material capable of handling the temperatures to which it is expected to be exposed.

The glass 12 may be retained to the support 38 by a retainer 58 preferably has upper and lower jaw members 60, 62. Jaw members 60, 62 preferably extend less than 0.7 inches such as 0.65 to provide a grip on the glass 12 of no more than about 0.5 inches at the edges. This is believed to be a significant improvement over prior art designs which maintain an inch of aluminum covering the edges. Therefore in a typical four foot by eight foot construction, approximately two square feet of additional collection area is provided. Furthermore, internal to the jaw members 60, 62, it is preferably grip 64 which could be a dual durometer applied material or other appropriate material such a one or more 0-ring(s), etc., which can assist in gripping the retaining glass 12 between the jaw members 60, 62. Other constructions can be utilized in other embodiments.

Lower portion 40 of support 38 can be shaped as designed to provide an angle relative to a roof in an effort to increase the efficiency of the collector 10 for at least some embodiments. Furthermore, the support 38 could be connected to a separate bonnet in a manner similar to former prior art designs. The illustrated configurations could also be connected to a bonnet. Additionally and/or alternatively, downwardly cantilevered extending fin 66 may be utilized to cooperate with roof flashing portion 68 so that the frame 14 may be connected directly to a roof of a building for at least some embodiments without a bonnet. Furthermore, the fins 66 are preferably separated from support 38 such as by slot 69 which may be of sufficient width to accommodate at least two sets of flashing 16 and/or. roof thicknesses such as shingles for at least some embodiments. Fins 66 are preferably cantilevered connected at ankle 70 which may extend outwardly relative to support 38. The fin 66 preferably downwardly extends relative to support 38 and/or ankle 70. The fin 66 extends, for at least some embodiments, at least half of a height of support 38 and may extend substantially the length of the heat chamber 24 for at least some embodiments.

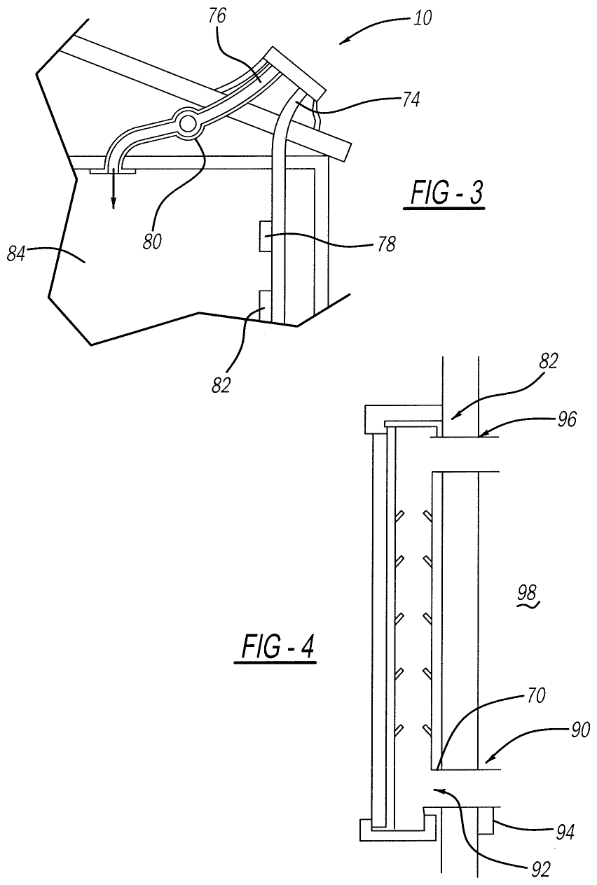

FIG. 3 shows a collector 10 connected to a roof 72. Inlet duct 74 is shown directing air towards inlet 20 as shown in FIG. 1 while outlet duct 76 is shown removing air from the collector 10. Other than inlet 20 and outlet 22, the collector 10 is preferably air tight for many embodiments. A control system 78 may be provided to adjust an amount of air flow such as that controlled by a blower or fan 80 or other mechanisms so that cold air such as taken in at return and/or intake 82 can then be provided through inlet duct 74 to collector 10. Discharge of heated air is directed out of duct 76 from outlet 22 into environment 84 such as around in the house and/or building. Other environments may utilize a blower/fan 80 on the intake side, if blowers are utilized in such embodiments.

Other embodiments may orient the collector 10 slightly differently such as seen in FIG. 4 where the intake duct 90 cooperates with inlet 20 directing air flow into such as past fan and/or blower 92 as may or may not be controlled by controller 94, if utilized, into the collector 10. Air that passes through the heat chamber 24 is preferably directed out outlet 22 and then outlet duct 96 back into the environment 98. All embodiments do not necessarily utilize blowers 92, as an active system. Some systems are significantly more passive, if not completely passive.

Numerous alterations of the structure herein disclosed will suggest themselves to those skilled in the art. However, it is to be understood that the present disclosure relates to the preferred embodiment of the invention which is for purposes of illustration only and not to be construed as a. limitation of the invention. All such modifications which do not depart from the spirit of the invention are intended to be included within the scope of the appended claims.

1. An improved solar space heater collector comprising:
a frame having sides defining a heat chamber between a top plate and an absorber, wherein said sides have at least one insulating pocket defined between an inner wall and a support, and said heat chamber being enclosed except for an inlet and an outlet through which air is directed to be heated while in the heat chamber.

2. The collector of claim 1 further comprising an extension, said extension contacting an insulator, said insulator at least substantially spanning an area of the absorber below the absorber.

3. The collector of claim 1 further comprising a ledge, said ledge having a lower surface, and said extension having an upper surface, with the lower surface of the ledge and the upper surface of the extension defining a slot into which the insulator extends along its perimeter.

4. The collector of claim 1 further comprising a baffle internal to the heat chamber, said baffle increasing a distance air must flow from the inlet to the outlet and the baffle increases the distance to at least twice a direct distance between the inlet and the outlet.

5. The collector of claim 1 further comprising a downwardly and cantilevered extending fin extending from the support externally relative to the inner wall, said fin and support defining a roofing material slot for cooperating with roofing material.

6. The collector of claim 1 wherein the absorber is a copper foil having a pre-treated length of at least 150% of a length of the collector.

7. The collector of claim 6 wherein the absorber is roll-formed to provide at least 0.25 inch extensions to thereby increase surface area of the absorber.

8. The collector of claim 1 wherein the frame sides are extended from HDPE.

9. The collector of claim 1 further comprising a retainer disposed toward the top of the support, said retainer having first and second jaws which receive no more than 0.7 inches of glass therebetween.

10. The collector of claim 9 further comprising a dual durometer grip internal to the first and second jaws contacting the top glass.

11. The collector of claim 1 further comprising a retainer disposed toward the top of the support, said retainer having first and second jaws and at least one dual durometer grip internal to the first and second jaws contacting the top glass.

12. An improved solar space heater collector comprising:
a frame having sides defining a heat chamber between a top plate and an absorber, wherein said sides have at least one cantilevered extending extension supporting at least one of an insulation panel and the absorber, and said heat chamber being enclosed except for an inlet and an outlet through which air is directed to be heated while in the heat chamber.

13. The collector of claim 12 further comprising an insulator and. a ledge defining a slot there between, said insulator at least substantially spanning an area of the absorber below the absorber and retained at its perimeter in the slot.

14. The collector of claim 12 further comprising a baffle internal to the heat chamber, said baffle increasing a distance air must flow from the inlet to the outlet to at least twice a direct distance between the inlet and the outlet.

15. The collector of claim 12 wherein the absorber is a copper foil having a pre-treated length of at least 150% of a length of the collector.

16. The collector of claim 15 wherein the absorber is roll-formed to provide at least 0.25 inch extensions to thereby increase surface area of the absorber.

17. The collector of claim 12 wherein the frame sides are extruded from HDPE and further comprising an internal wall, said internal wall and said support defining at least one insulating pocket therebetween.

18. The collector of claim 12 further comprising a retainer disposed toward the top of the support, said retainer having first and second jaws which receive no more than 0.7 inches of glass therebetween.

19. The collector of claim 18 further comprising a dual durometer grip internal to the first and second jaws contacting the top glass.

20. The collector of claim 12 further comprising a retainer disposed toward the top of the support, said retainer having first and second jaws and at least one dual durometer grip internal to the first and second jaws contacting the top glass.
